(19) United States
(12) Patent Application Publication
(10) Pub. No.: US 2006/0182074 A1
(43) Pub. Date: Aug. 17, 2006

(54) Configurable premises based wireless network and operating protocol

(76) Inventors: Joseph J. Kubler, Boulder, CO (US); Ronald L. Mahany, Cedar Rapids, IA (US)

Correspondence Address: JOHN H. SHERMAN, LEGAL DEPT.;INTERMEC TECHNOLOGIES CORPORATION, 550 2ND STREET SE, CEDAR RAPIDS, IA, 52401, US

(21) Appl. No.: 11/288,024

(22) Filed: Nov. 28, 2005

Related U.S. Application Data
(63) Continuation of application No. 10/765,451, filed on Jan. 27, 2004, now abandoned.
Application No. 10/765,451 is a continuation of application No. 09/092,450, filed on Jun. 5, 1998, now abandoned.
Application No. 09/092,450 is a continuation-in-part of application No. 08/911,318, filed on Aug. 14, 1997, now abandoned.

(30) Foreign Application Priority Data
Jun. 3, 1996 (WO) PCT/US96/09474

(51) Int. Cl. H04Q 7/24

(52) U.S. Cl. 370/338; 370/401

(57) ABSTRACT

A premises based wireless network includes a plurality of interconnected wireless access points. Each of the plurality of wireless access points provides wireless communications within a corresponding cell of a plurality of cells and is spaced to provide wireless coverage throughout the premises. The size of at least one cell of the plurality of cells is adjustable based upon cell communication characteristics. In order to adjust the size of a cell, the corresponding operating data rate is selectively adjusted. In particular, the size of the cell is increased by reducing the data rate or throughput capability. For example, at least one wireless access point may operate according to an industry standard protocol at a standard data rate with a relatively smaller cell size, and another may operate according to a proprietary protocol. A dual mode base station of the plurality of base stations may operate according to both the industry standard protocol and the proprietary protocol. At least one of the plurality of wireless access points may be selectively disabled, whereas another have its data rate to increase a corresponding cell size. In the network, a selectively disabled base station monitors communications within a previously active corresponding cell. Based upon the monitored communications, the selectively disabled base station becomes active to provide wireless communications within a corresponding cell.

### CROSS-REFERENCES TO RELATED APPLICATIONS

The present application is a continuation of application Ser. No. 10/765,451 filed Jan. 27, 2004, which is a continuation of application Ser. No. 09/092,450 filed Jun. 5, 1998, now abandoned, which is a continuation-in-part of application Ser. No. 08/911,318 filed Aug. 14, 1997, now abandoned.

PCT Application No. PCT/US96/09474 filed Jun. 3, 1996, published as WO 96/38925 dated 5 Dec. 1996, and U.S. application Ser. No. 08/645,348 filed May 13, 1996, are both hereby incorporated herein by reference in their entirety.

### BACKGROUND

1. Technical Field

The present invention relates generally to a communication network having wireless access point devices that support wireless communications within a premises; and, more specifically, to a wireless network having configurable wireless access points that alter various operating parameters in a wireless microcell network.

2. Related Art

To establish a conventional wireless network in a larger premises, a plurality of wireless access points or base stations may be installed. Each wireless access point provides wireless coverage in a certain portion of, or “cell” within, the premises. The cells of coverage are arranged to support wireless communication throughout the premises. Often, such installation is referred to as a wireless microcell network.

The wireless access points in conventional microcell networks each support the same data rate and corresponding cell size. The data rate and cell size of such access points define an upper limit of channel capacity and throughput supported. Thus, each cell in the microcell network is capable of supporting the same throughput and coverage area.

However, in many microcell network installations, a substantial volume of communication traffic occurs only in certain of the cells with light traffic in the others. For example, such is the case in warehouse premises where high volume cells are located in the dock area The wireless access points supporting wireless activities near the docks need to handle significantly more traffic than the wireless access points supporting the remainder of the warehouse. For example, the data rate of the wireless access points located at the docks must be great enough to support the high traffic at the docks. Wireless access points available in the market can provide the required throughput. They may be deployed throughout the warehouse and located at strategic places to cover the entire warehouse. However, if such wireless access points are deployed throughout the warehouse, the high data rates that they provide will be required for the docks but unnecessary for the rest of the warehouse. With the deployment of these wireless access points throughout the warehouse, the wireless coverage of all sections of the warehouse can be ensured, but with several underutilized wireless access points in low traffic zones.

To achieve high throughput without increasing both power and data rate, the data rate may still be increased though cell size must decrease, increasing the number of wireless access points required to support a premises. This significantly increases the number of underutilized cells, complicating the installation.

### SUMMARY OF THE INVENTION

In order to overcome the limitations of prior devices and other limitations, a premises based wireless network includes a plurality of interconnected base stations or wireless access points. Each of the plurality of wireless access points provides wireless communications within a corresponding cell of a plurality of cells and is spaced to provide wireless coverage throughout the premises. The size of at least one cell of the plurality of cells adjustable based upon cell communication characteristics. In order to adjust the size of the at least one cell, an operating data rate of at least one of corresponding base station is selectively adjusted to alter the size of a corresponding cell. Thus, the size of the corresponding cell may be effectively decreased.

An operating data rate of at least one of the base stations may be selectively increased to increase data throughput capability within a corresponding cell. In one implementation, the data rate of a first wireless access point is selectively adjusted to increase data throughput capability within a corresponding cell and to reduce the size of the corresponding cell while the data rate of a second wireless access point, neighboring the first wireless access point, is selectively adjusted to increase the size of a corresponding cell.

In the wireless network, at least one of the plurality of wireless access point may operate according to a first protocol at a first data rate. Simultaneously, at least one of the plurality of wireless access points may comprise a dual mode wireless access point capable of operating according to a second protocol that is substantially compliant with the first protocol, but that operates at a relatively lower data rate and within a relatively larger cell size. In such installation, for example, a dual mode base station of the plurality of base stations may operate according to both the industry standard protocol and the proprietary protocol. At least one wireless terminal may be provided that communicates with the dual mode wireless access point within a corresponding cell according to the second protocol.

Further, a roaming wireless terminal may be provided that can only operate according to the first protocol, which enters the cell corresponding to the dual mode wireless access point. The dual mode wireless access point establishes communication with the roaming wireless terminal according to the first protocol. Alternatively, the dual mode wireless access point adjusts the corresponding cell to operate according to the first protocol, or communicates with the other of the plurality of wireless access points to adjust operation to the first protocol.

In the premises based wireless network, at least one of the plurality of wireless access points may be selectively disabled such that it does not provide wireless communications. Further, at least one other of the plurality of wireless access points may adjust its data rate to increase a corresponding cell size to provide wireless communications in portions of the premises that were previously covered by the at least one selectively disabled wireless access point. In the network, the selectively disabled wireless access point monitors communications within a previously active corresponding cell. Based upon the monitored communications, the selectively disabled wireless access point becomes active to provide wireless communications within a corresponding cell.

A method of providing wireless communications within a premises according to the present invention includes operating a first wireless access point within the premises to support wireless communications at a first data rate in a first cell having a first size within the premises, adding and operating one or more second wireless access points to support wireless communications at a second data rate in one or more corresponding second cells within the premises, and adjusting operation of the first wireless access point by increasing the data rate above the first data rate and correspondingly reducing the size of the first cell. The method may further comprise adjusting operation of the first wireless access point by reducing the size of the first cell so that the first and one or more second cells substantially cover the entire premises and so that the first and one or more second wireless access points operate at a data rate that is greater than the first data rate. Further, operation of the one or more second wireless access points may be suspended while communication demands are reduced. Operation of the first wireless access point may be adjusted to the first data rate in the first cell at the first size while communication demands are reduced.

The method may further comprise coupling the first and one or more second wireless access points together, such as with a backbone network or the like. The first wireless access point monitors communications within the premises and requests that the one or more second wireless access points suspend communications while communication demands are reduced, and the first wireless access point resumes operation at the first data rate in the first cell at the first size. The method may further comprise the first wireless access point requesting that each of the second wireless access point suspends communications while communication demands are reduced, in which case the first wireless access point resumes operation at the first data rate in the first cell.

Moreover, other aspects of the present invention will become apparent with further reference to the drawings and specification which follow.

### BRIEF DESCRIPTION OF THE DRAWINGS

A better understanding of the present invention can be obtained when the following detailed description of the preferred embodiment is considered in conjunction with the following drawings, in which:

FIG. 1 is a perspective diagram showing a wireless network with two base stations within a premises, each of the base stations being capable of communications with a plurality of network devices;

FIG. 2 is a perspective diagram showing a wireless network where one of the base stations of FIG. 1 lowers its data rate and extends its wireless coverage to sections of a premises previously covered by one or more base stations that reduced their coverage and increased their data rate;

FIG. 3 is a perspective diagram showing the wireless network of FIG. 2 with additional base stations to offer higher data rates and handle higher traffic, each base station in the wireless network operating at a relatively higher data rate and with correspondingly lower wireless coverage;

FIG. 4 is a perspective diagram showing the wireless network of FIG. 3 with some of its base stations switched to a dormant state and others converted to a lower data rate network while extending their coverage to encompass sections of the premises previously covered by the dormant base stations;

FIG. 5 is a perspective diagram showing one of the dormant base stations of FIG. 4 automatically activating its coverage based on traffic and network status monitored during its dormant state;

FIG. 6 is a flow diagram illustrating operation of a wireless network constructed according to the present invention in altering operating configurations of at least one base station within the wireless network based upon various system conditions;

FIG. 7A is a perspective diagram showing another exemplary wireless microcell network supported by a single wireless access point within a premises;

FIG. 7B is a perspective diagram of the wireless microcell network of FIG. 7A including additional wireless devices and wireless access points to support the additional wireless devices; and

FIG. 7C is a perspective diagram of the wireless microcell network of FIG. 7B during reduced activity in which several of the wireless devices are dormant or inactive, so that one or more of the wireless access points are switched to a dormant mode and one wireless access point is switched to support the premises.

### DETAILED DESCRIPTION OF THE DRAWINGS

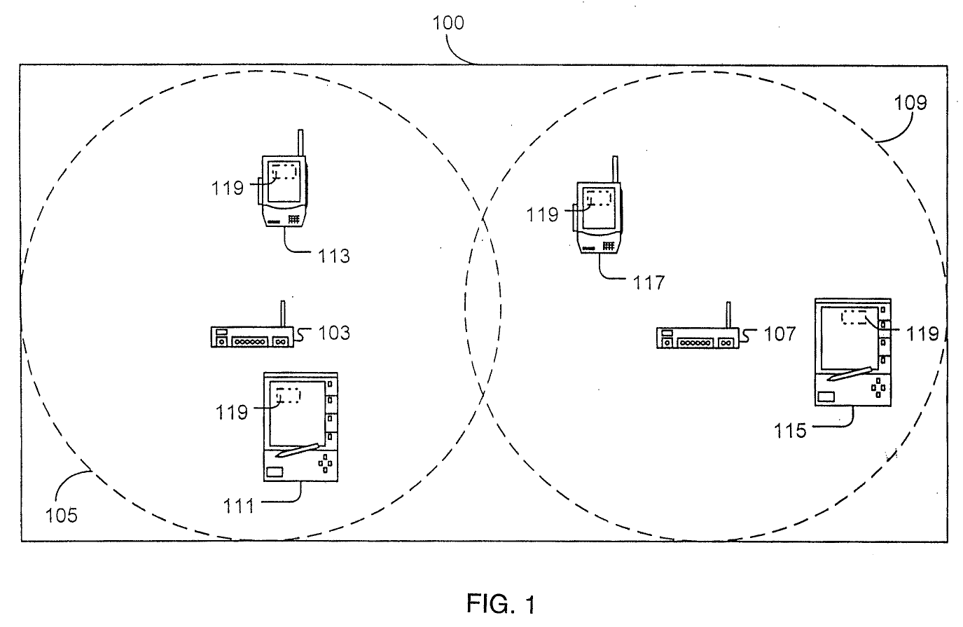

FIG. 1 is a perspective diagram showing an exemplary wireless microcell network supported by two wireless access points or base stations 103, 107 within a premises 100. Each of the base stations 103, 107 are capable of communications with a plurality of network devices, such as wireless devices 111, 113, 115, 117. The base stations 103 and 107 are located such that they provide complete coverage of the premises 100.

With relatively uniform traffic flow through the premises 100, the base station 103 provides coverage over the area 105 while the base station 107 provides coverage over the area 109. The base stations 103 and 107 are capable of adjusting their coverage areas based upon the traffic and other operating conditions within the premises 100. The coverage area can be considered a cell and the traffic in each cell may be monitored by the associated base station.

Relatively lower data rates may be provided according to a proprietary protocol which, while being compatible with industry standard protocol for wireless LAN (local area network) communications, such as IEEE 802.11, allows for coverage of the premises 100 by fewer base stations. However, the base stations 103 and 107 can easily and automatically switch to industry standard protocol when necessary, albeit with changes in their data rates. Such data rate changes may be necessary if some of the wireless devices employed in the coverage areas 105, 109 cannot operate with the non-standard proprietary protocol of the base stations 103, 107 and can only operate according to industry standard protocols.

With the two base stations 103 and 107, the premises can be provided with complete and upgradeable wireless coverage. Additional base stations can be installed if the data rates of the base stations 103 and 107 are increased to accommodate more traffic. In an exemplary embodiment of the present invention, base stations 103 and 107, operating at the industry standard protocol, provide for data rates in the order of 1 Mbps. However, employing the proprietary protocol, they reduce their data rates to 250 kbps while increasing their coverage area substantially. Employing relatively larger cell sizes or coverage areas for the base stations reduces the number of base stations that are required to provide wireless coverage throughout the premises.

When determining the type of wireless radio to install at a premises, it is important to consider the size and physical layout of the site and the amount of traffic that will flow through the network. Typically, radio ranges decrease as radio frequency and data speed increase. Base stations can employ one or more of a variety of radios, typical frequency bands for the radios being 900 MHz, UHF and 2.4 GHz. The 900 MHz band is a good choice for large populations of stations, or for environments where high performance is required. It is typically recommended for light to medium density data applications in factories and other large spaces. The 900 MHz radio does not require a site license.

The UHF option of radio typically has the largest or best coverage but the lowest data rate. It can be employed for low to medium populations of terminal emulation stations. The UHF radio often requires a site license. The highest data rates, of the listed bands, are possible by operating at the 2.4 GHz band. Radio devices in this band commonly provide the highest data rates but the lowest or smallest coverage area Therefore, the 2.4 GHz band is a good choice when file transfers are regular or information-intensive applications requiring high throughput need to be supported. Recently, the IEEE 802.11 standard was adopted, which supports both 1 Mbps and 2 Mbps operation. The 802.11 committee is studying alternatives for 10 Mbps operation at 2.4 GHz.

The wireless devices 113 and 111 operating in the coverage area 105 are only exemplary, and a plurality of similar wireless devices may be operating in the coverage area 105. Similarly, the wireless devices 117 and 115 operating in the coverage area 109 are only exemplary, and a plurality of similar wireless devices may be operating in the coverage area 109. These wireless devices 111, 113, 115, and 117 each include a radio 119 that operates at more than one data rate, depending on the coverage. In general the base stations 103 and 107 interact with the radios of the wireless devices in their coverage areas, 105 and 109, respectively, to configure them with required operational parameters. The wireless devices 113, 111, 117, and 115 each may include more than one radio 119. The data rates of each radio 119 in each wireless device may be altered by appropriate configuration commands from an associated base station.

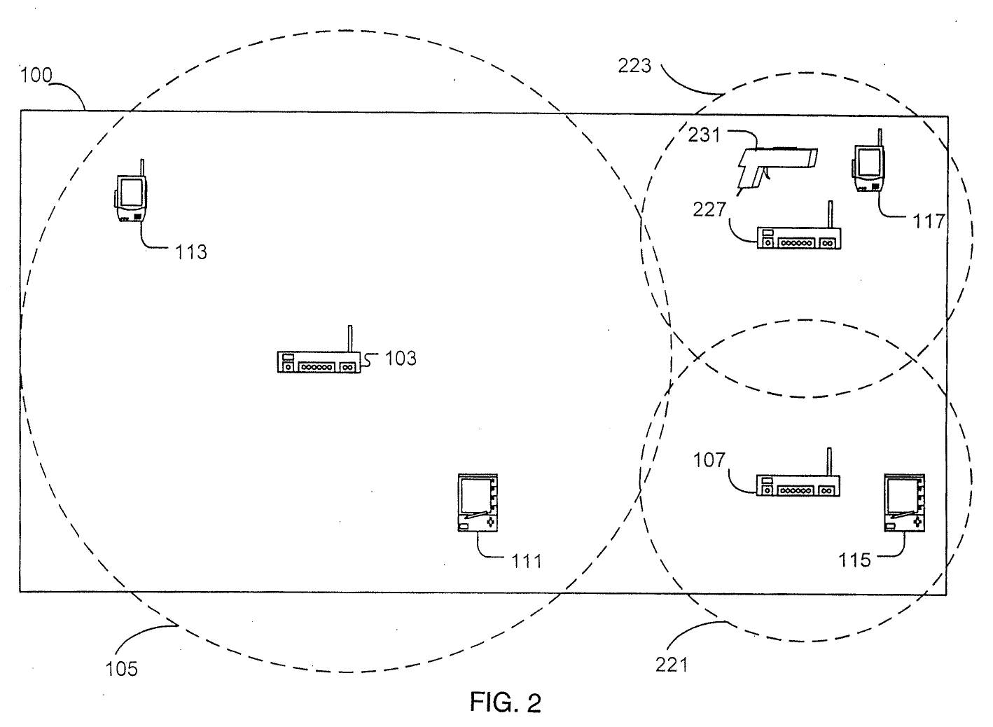

FIG. 2 is a perspective diagram showing a wireless network within the premises 100 where one of the base stations 103 of FIG. 1 lowers its data rate and extends its wireless coverage to sections of the premises 100 previously covered by one or more base stations that later reduced their coverage to increase their data rate. Specifically, the base station 107 increases its data rate and reduces its coverage 221 in order to support more wireless devices and the consequent increase in throughput. Such a scenario often occurs when the work being performed in certain sections of the premises 100 increases due to changing business conditions or changing work processes. In response to the changing business needs, additional personnel may be put to work in the premises 100, each operating a plurality of wireless network devices, such as a personal digital assistant (PDA) 117 and a data collection device 231, within the premises 100. The base station 107 determines that the traffic cannot be handled at the lower data rate and decides to recommend an increase in its data rate. Subsequently, a wireless access point 227 is installed to support the additional wireless network devices introduced into the network and to allow base station 107 to increase its data rate. The base station 227 is also initiated at the higher data rate to enable high traffic levels in that section of the premises 100.

The base stations 103, 107, 227 make it possible to customize the network to the requirements of the work groups using them. Work groups that require higher data rates can change the configuration of an associated base station in their coverage area accordingly. For smaller work groups that value flexibility and upgradeability more than conformance to a standard protocol such a network with base stations 103, 107, 227 that support both a standard and a proprietary protocol (proprietary extensions to standard protocol) is an appropriate and viable choice. The availability of the standard protocol on the base station makes it possible to include equipment in the future, if necessary, that are conformant only to the standard protocol. The wireless networks in the premises 100 established by the base stations 103, 107, 227 are therefore not locked into proprietary protocols.

The base stations 103, 107, and 227 are interconnected and form part of an infrastructure network. Each of these base stations therefore provide wireless communications within their respective coverage areas or “cells”, 105, 221 and 223. The size of these cells are configurable. Together, they provide wireless coverage throughout the premises 100.

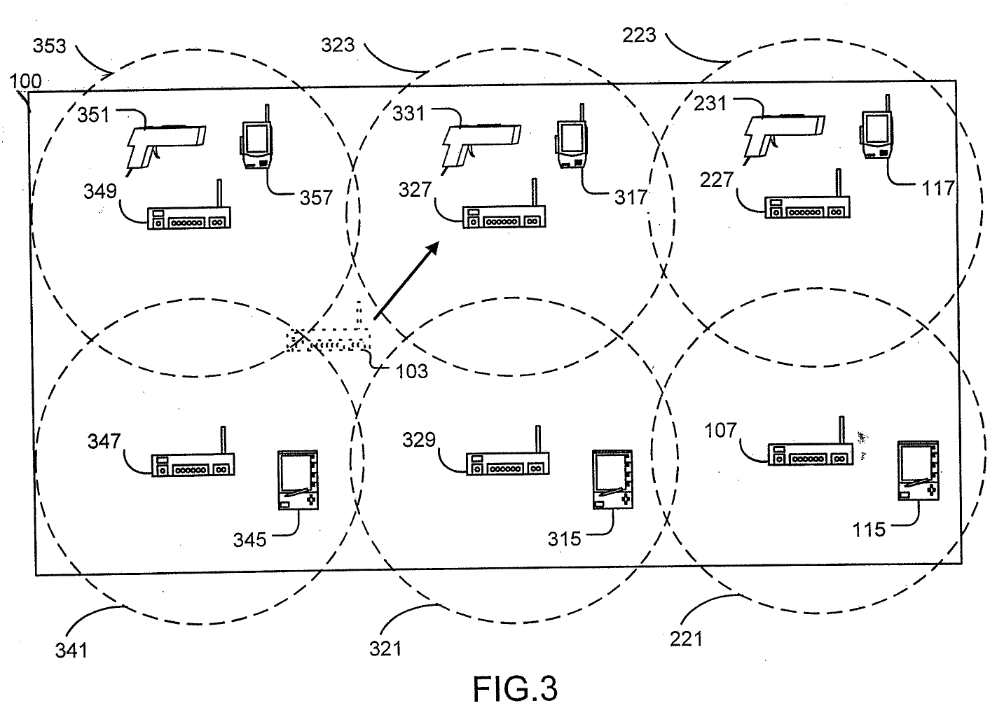

FIG. 3 is a perspective diagram showing the wireless network of FIG. 2 with additional wireless access points 329, 347, and 349 installed to offer higher data rates and to handle higher traffic levels. Each base station in the wireless network premises 100 operates at a relatively higher data rate and with correspondingly lower wireless coverage area. The wireless base station 103 is moved to a new location so as to provide wireless coverage in the area 323. As a wireless access point 327, it is operated at the higher data rate with lower coverage area 323.

With six base stations, the premises 100 can support substantially more wireless devices and at higher data rates than with the configuration described previously with reference to FIG. 1. This change in configuration is obtained without discarding or replacing any of the base stations from the configuration of FIG. 1. Therefore, the configuration with these six base stations 107, 227, 329, 327, 347, and 349 is an upgrade facilitated by the ability of the base stations to adapt themselves to changing requirements of data rates and coverage area.

It is possible to reconfigure the wireless network collectively formed by the six base stations 107, 227, 329, 327, 347, and 349. For example, if additional base stations need to be added to support additional wireless devices that may be added to the premises, and its associated traffic, they may be added after reconfiguring the coverage areas of some or all of these base stations. Again, if the traffic in some of the coverage areas 221, 321, 341, 223, 323, and 353 drastically reduces and falls below a threshold, the associated base station may be turned off or put temporarily into a dormant state. In addition, the coverage of one or more adjacent active base station is extended to include the areas previously supported by the dormant base stations.

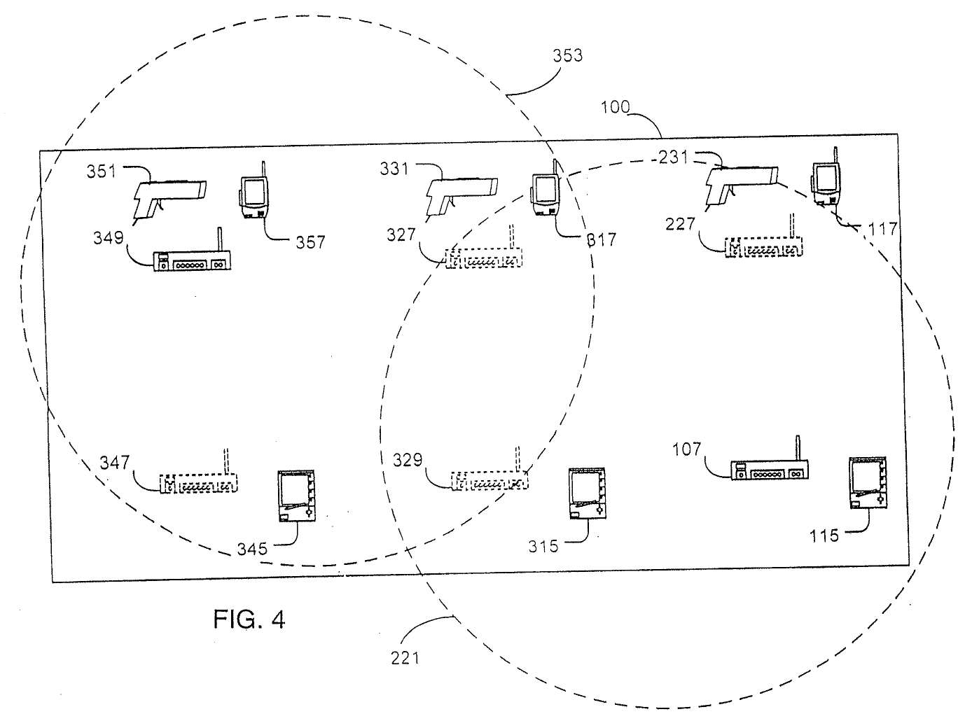

FIG. 4 is a perspective diagram showing the wireless network of FIG. 3 with some of its base stations 327, 329, 347, and 227 switched to a dormant state and others 107 and 349 converted to a lower data rate network while extending their coverage to encompass sections of the premises previously covered by the dormant base stations. When the installed base stations experience low data traffic, they can be turned off or put into a dormant state. To ensure complete wireless coverage of the premises 100, the other base stations are made to provide wireless communications to the sections of the premises previously covered by the dormant base stations 227, 329, 327, and 347. This would require the base stations 107 and 349 to lower their data rates and extend their wireless coverage areas 221 and 353, respectively.

The base stations 227, 329, 327, and 347 that are put into a dormant state may selectively continue to monitor the activities in the wireless network within the premises 100. Such monitoring need not be continuous-it can be made periodically. When a dormant base station deems it necessary to activate itself to provide wireless communications within its range, it does so automatically. This can occur for several reasons-for increased network traffic in its vicinity, for failure of another active base station to provide wireless coverage in its proximity, or due to timed resumption after a scheduled dormant state. Wireless devices that are switched from one base station about to become dormant to another base station that is about to extend its range may experience minimal disruption. The hand-off from one base station to another may be coordinated using a coordination protocol between base stations.

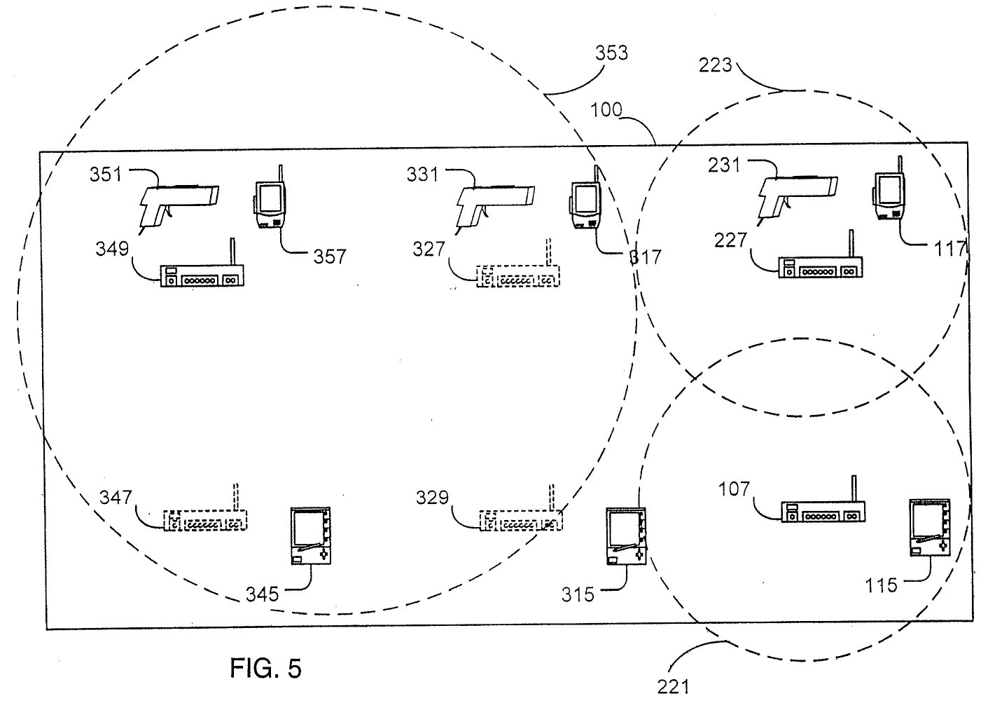

FIG. 5 is a perspective diagram showing one of the dormant base stations 227 of FIG. 4 automatically activating its coverage based on traffic and network status monitored during its dormant state. When the base station 107 supporting the coverage area 221 experiences increased traffic and higher throughput, it decides to increase its data rate and broadcasts an indication of a higher data rate for its coverage area 221. Such a broadcast message may be received by the dormant base station 227, which also monitors the traffic in its coverage area to determine the need to become active again. If the base station 227 decides to get out of the dormant state and become active again, it coordinates its resumption of activity with the base station 107. The base stations 107 changes its operation to a higher data rate and lower coverage, while the base station 227 resumes its coverage of the area 223 in its proximity.

The base station 329 also receives the broadcasts message recommending a higher data rate sent by the base station 107. However, from the information collected by its monitoring activities, it determines that the traffic in its coverage area does not necessitate its resumption of coverage. Therefore, it continues to stay dormant and monitor the traffic situation.

As is evident from the foregoing discussions, wireless networks within premises may be initially configured to reduce cost by installing a minimum number of base stations to provide coverage throughout the premises. Then, as traffic demands require, additional base stations may be added to service the increasing traffic.

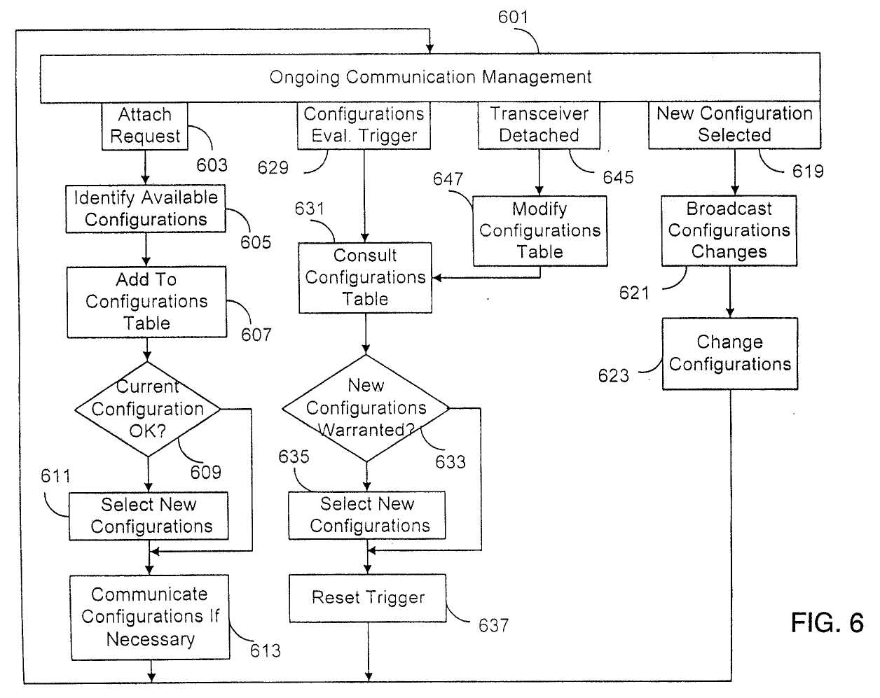

FIG. 6 is a flow diagram illustrating the operation of a wireless access device in accordance with present invention whereby multiple wireless devices having potentially different transceiver capabilities are supported. In particular, a wireless access device manages ongoing communication within its cell with a previously selected configuration and configuration parameters at a block 601. At a block 603, the wireless access device identifies an attach request from a wireless transceiver (hereinafter the “requesting transceiver”) that may have entered the cell. The access device 603 responds at a block 605 by identifying the available configurations of operation of the requesting transceiver. For example, the particular requesting transceiver may operate only at a relatively higher data rate, a relatively lower data rate, or both. At a block 607, the configurations are added to a configuration table, which stores the available configurations of all the participating devices. Note that a requesting transceiver only communicates the availability of those configurations which are both possible (determined by the transceiver's design) and useful (determined by a current application).

If the requesting device is capable of operating in the currently selected configuration, as determined at a block 609, the wireless access device communicates configuration information and parameters to the requesting transceiver at a block 613. Thereafter, the wireless access device returns to the block 601 and services all participating devices including the requesting device in the current configuration with current parameters.

Alternatively, if the requesting device has a limited number of operating configurations, at the block 609 the current configuration may not be a possibility. If the requesting device is not capable of operating in the current configuration, the wireless access device attempts to select a new configuration at a block 611. If at least one common configuration can be found, e.g., if all the participating devices and the requesting device have at least one common configuration, the wireless access device chooses the common configuration that it believes will offer optimal performance. Thereafter, at a block 613, the wireless access device communicates the selected configuration and parameter information to the requesting transceiver at the block 613 and returns to the block 601. At the block 601, because a new configuration has been selected, the wireless access device vectors to service the event at a block 619. At a block 621, the wireless access device broadcasts the configuration and parameter information, and, at a block 623, changes its own configuration. Thereafter, the wireless access device returns to service ongoing communication in that configuration at the block 601.

If however a common configuration cannot be found for a requesting transceiver at the block 611, the requesting transceiver may be rejected from participating. In such a case, the customer must identify the radios causing the limitations and upgrade them. In another embodiment, the wireless access device operates in a time shared configurations, switching between two or more configurations in a sequential fashion. In this embodiment, however, the overall delays in the system may still justify upgrading the radio transceiver(s) causing the limitations.

During the course of ongoing operation at the block 601, the wireless access device monitors channel performance (a variety of factors described in more detail above), and compares such performance to available other common configurations of operation and considers potential parameter modifications. In particular, as represented by the block 629, if channel conditions degrade below a predefined threshold, the wireless access device vectors to consider changing configurations. When ongoing traffic on the particular channel exceeds a threshold, the access point may determine that a new configuration is warranted. At a block 631, the wireless access device consults the configuration table. If a new configuration is available and warranted, per a determination at a block 633, the wireless access device responds by selecting an alternate common configuration at the block 635, resets the conditions that caused the vectoring at block 637 and returns to the block 601 to complete the configuration change via the blocks 619, 621 and 623.

Similarly, each time a participating transceiver detaches from the cell (through either active detachment or inactivity time-out) as represented by an event block 645, the wireless access device removes that transceiving device's configuration information from active status in the configuration table at block 647 and attempts to choose a better common configuration via the blocks 631, 633, 635 and 637. Although not shown, the wireless access device might also periodically attempt to choose a better common configuration, without requiring channel conditions to change or degrade or participants to detach.

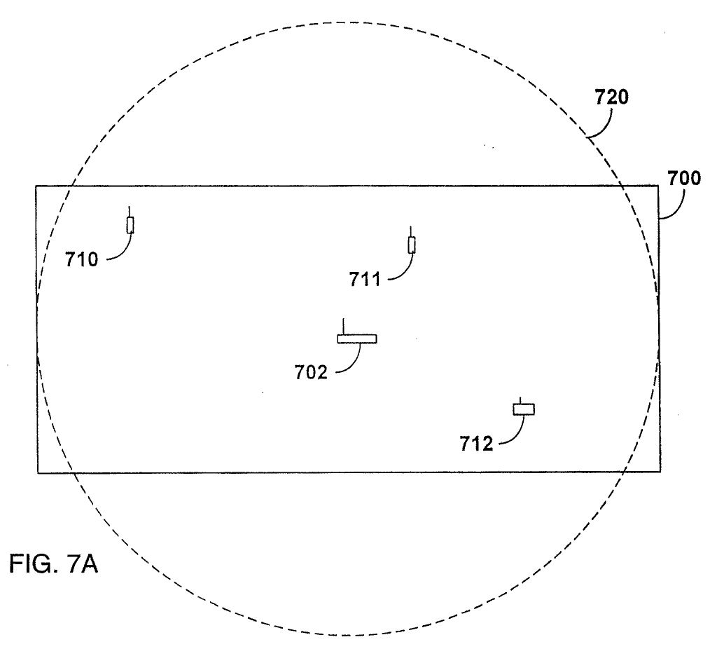

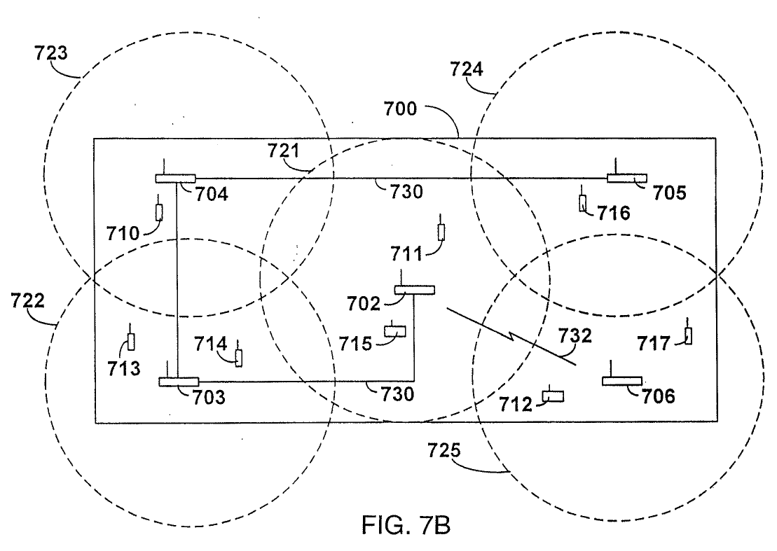

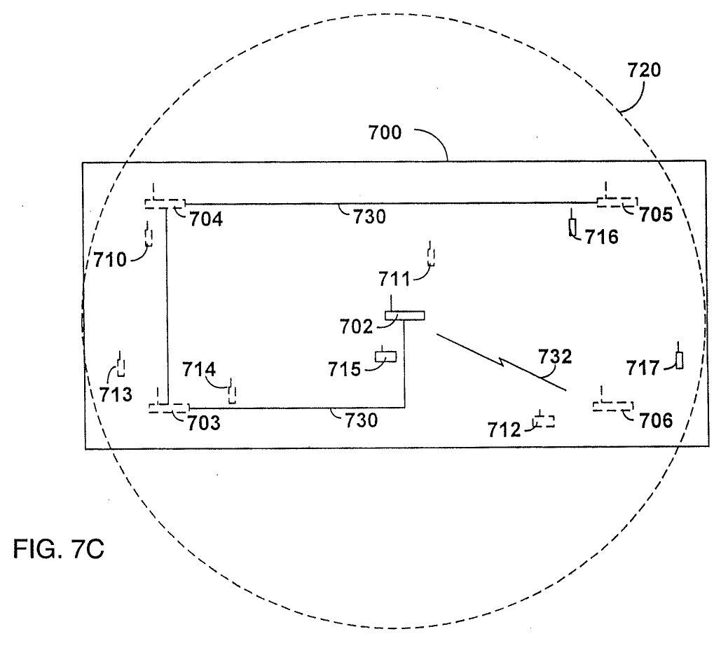

FIG. 7A is a perspective diagram showing another exemplary wireless microcell network supported by a single wireless access point 702 within a premises 700. The Federal Communications Commission (FCC) regulates the operation and power output of wireless devices, such as the wireless access point 702, to various communication parameters, e.g., a particular maximum power level. The wireless access point 702 may operate according to any one of several data rates, protocols or protocol variations depending upon the number of wireless devices supported and the requisite data throughput to support those devices. For example, the wireless access point 702 may operate according to an industry standard protocol, such as according to the IEEE 802.11 standard, or may alternatively operate according to a proprietary protocol that is compatible with the standard protocol but, for example, operates at a relatively lower data rate and an increased coverage area. Thus, the data rate of operation of the wireless access point 702 may be reduced to increase the area of coverage.

The wireless access point 702 provides wireless communication support for a plurality of wireless devices, such as wireless devices 710, 711, 712 as shown. This may represent an initial configuration of the wireless network within the premises 700 in which there are relatively few wireless devices to support. The wireless access point 702 and each of the wireless devices 710-712 may operate at a relatively high data rate, such as 1 or 2 Mbps, but the resulting area of coverage of the wireless access point 702 may be too small to support substantially the entire area of the premises 700. The wireless access point 702 and each of the wireless devices 710-712 may also operate at a reduced data rate, such as 250 kbps, resulting in a larger area in coverage. It may be determined that a lower data rate is acceptable for supporting the wireless devices 710-712. In that case, the wireless access point 702 is located and operated to provide wireless communication support within a relatively large cell 720 and at a reduced data rate, which provides coverage of the premises 700 to adequately support a number of wireless devices such as the wireless devices 710-712 operating in the premises 700.

At the selected data rate, the single wireless access point 702 may become inadequate to support the wireless network should throughput demands increase. This may occur when a customer adds many more wireless devices to the network or otherwise changes the data requirements of the network. With conventional installations, such changes would require replacement of not only the wireless access point 702 but also the replacement of the wireless devices 710-712 to, for example, accomodate different and incompatible radio technologies, protocols, data rates, etc. Such replacement is not required in the wireless network of the present invention as is illustrated for example in FIG. 7B.

Specifically, FIG. 7B is a perspective diagram of the wireless microcell network of FIG. 7A, wherein further wireless access points have been added to support higher throughput requirements required by a higher number of wireless devices as represented by additional wireless devices 713, 714, 715, 716 and 717 within the premises 700. Several more wireless access points 703, 704, 705 and 706 are provided and distributed within the premises 700 to support the wireless devices 710-717. For example, the wireless access points 703-706 are placed around the wireless access point 702, located substantially in the center, towards the four corners, respectively, of generally rectangular the premises 700. The wireless access points 703-706 support wireless communications within respective cells 722, 723, 724 and 725. The respective cells 721-725 may overlap as necessary. Of course, a premises to be supported with wireless communication need not be rectangular or have any particular shape or configuration. In any given premises, one or more wireless access points are distributed in an appropriate manner to provide substantially complete or any desired coverage. The size and shape of a given premises, the number of wireless devices to be supported and the area of coverage of the wireless access points may be considered to determine the number of wireless access points needed.

As shown in FIG. 7B, the wireless access points 702-706 are positioned in view of the size and shape of the premises and the respective size of the cells 721-724 to provide support for substantially the entire area of the premises 700. The wireless access point 702 supports the wireless devices 711 and 715 within the cell 721, the wireless access point 703 supports the wireless devices 713 and 714 within the cell 722, the wireless access point 704 supports the wireless device 710 within the cell 723, the wireless access point 705 supports the wireless device 716 within the cell 724, and the wireless access point 706 supports the wireless devices 712 and 717 within the cell 725. It is understood, however, that one or more of the wireless devices 710-717 may be mobile and may roam into and out of any of the cells within the premises 700. Wireless communications may be transferred to a new wireless access point when a wireless device roams out of one cell and into another.

Upon adding the wireless access devices 703-706, the wireless access device 702 is merely reconfigured along with the wireless access devices 703-706 to support the new network requirements. For example, to support the new network requirements, the data rate of the wireless access device 702 is increased without increasing transmission power. Of course this change correspondingly decreases the effective size of each cell, thus requiring the increased number of wireless access devices to provide coverage throughout the premises. Alternately or additionally, the communication protocol used by the wireless access device 702 may be changed to better support the new network requirements.

All such changes in the wireless network of the present invention occur through configuration of the various network devices. In particular, the wireless access point 702 can be reconfigured through direct user interaction with therewith, or through user interaction from any network terminal device within the wired or wireless portion of the overall communication network. The wireless access points 703-706 may be similarly configured. Correspondingly, although the wireless devices 710-717 may be similarly configured, they may also be configured “on the fly” through interaction with any of the (re)configured wireless access points 702-706.

The level of wireless communication activity within a given premises often varies over time. Although all of the wireless devices 710-717 may all be operating during peak periods, several devices may be idle or dormant during other, low volume periods. For example, as shown in FIG. 7C, the wireless devices 715-717 are still operating, whereas the wireless devices 710-714 are dormant as indicated by dashed lines. The wireless access point 702 and each of the wireless devices 715-717 may be configured to operate at a reduced data rate resulting in a larger area in coverage. It may be determined that a lower data rate is acceptable for supporting the wireless devices 715-717. In this manner, the operation of the wireless access point 702 is modified to provide wireless communication support within the larger cell 720 and at the reduced data rate and/or with an alternate protocol as previously described, which provides adequate coverage of the premises 700 to support the wireless devices 715-717 in the premises 700. The wireless access points 703-706 may be temporarily shut off or otherwise temporarily suspended or made dormant, as shown by dashed lines. If and when additional wireless devices become active and wireless communication increases, the operation of the wireless access points 702-706 are modified back to an active state such as shown in FIG. 7B.

The wireless access points 702-706 may be coupled together via a backbone 730, such as a 10Base-T or 100Base-TX wired network or the like. The backbone 730 may also include one or more wireless links. For example, the wireless access point 706 is linked to the backbone 730 via a wireless link 732 to the wireless access point 702, where the wireless link 730 is considered as part of the backbone 730. Any one or more of the wireless access points 702-706 is configured to monitor communications with the respective cells 720 or 721 and 722-725, or within the entire premises 700, if desired. In one embodiment, the wireless access point 702 is configured to monitor the amount or level of communications of all of the wireless access points 702-706 coupled to the backbone 730. During slower periods or periods of relative inactivity, such as shown in FIG. 7C, the wireless access point 702 communicates to the wireless access points 703-706 via the backbone 730 to switch to a dormant mode. The wireless access point 702 also reduces its data rate to increase its cell size, such as to the cell 720, to maintain wireless support in the premises 700 while operating at the same transmission power level. When more wireless devices become active, the wireless access point 702 increases its data rate reducing its cell size, such as back to the cell 721, and further communicates to the wireless access points 703-706 via the backbone 730 to switch back to an active mode. The wireless access point 702 may also switch protocols to better support the differing cell sizes and data rates.

It may be desired that all of the wireless devices 710-717 operating within the premises be capable of operating at either data rate or protocol selected by one or more of the wireless access points 702-706. However, one or more of the wireless devices 710-717 may be capable of operating at only one protocol or data rate, such as that determined to be an industry standard. Suppose, for example, that the wireless access points 702-706 operate according to an industry standard protocol when operating at a standard data rate within the respective cells 721-725 as shown in FIG. 7B, and that the wireless device 714 only operates according to the industry standard protocol. If the wireless device 714 becomes active while the wireless access point 702 is operating at the reduced data rate within the cell 720 as shown in FIG. 7C, then communication with the wireless device 714 may not be supported. The wireless access point 702 detects activation of the wireless device 714, selectively switches its operation back to the standard data rate and cell size 721 and communicates to the other wireless access points 703-706 to become active and operate according to the standard protocol as shown in FIG. 7B. In an alternative embodiment, the wireless access point 702 detects activation of the wireless device 714, and switches to the industry standard protocol and data rate within the cell 720 or 721. In yet another embodiment, the wireless access point 702 establishes communication with the wireless device 714 at the standard protocol or data rate while maintaining communication at the reduced data rate with other wireless devices in the cell 720.

In view of the above-detailed description of the present invention and associated drawings, other modifications and variations will now become apparent to those skilled in the art. It should also be apparent that such other modifications and variations may be effected without departing from the spirit and scope of the present invention as set forth in the claims which follow.

1. A method of providing wireless communications within a premises, comprising:
operating a first wireless access point within the premises to support wireless communications at a first data rate in a first cell having a first size within the premises;
adding and operating a second wireless access point to support wireless communications at a second data rate in a second cell within the premises; and
adjusting operation of the first wireless access point by increasing the data rate above the first data rate and correspondingly reducing the size of the first cell.

2. The method of claim 1, further comprising:
the adjusting operation of the first wireless access point comprising reducing the size of the first cell so that the first and second cells substantially cover the entire premises and so that the first and second wireless access points both operate at a data rate that is greater than the first data rate.

3. The method of claim 2, further comprising:
suspending operation of the second wireless access point while communication demands are reduced; and
adjusting operation of the first wireless access point to the first data rate in the first cell at the first size while communication demands are reduced.

4. The method of claim 2, further comprising:
coupling the first and second wireless access points together;
the first wireless access point monitoring communications within the premises and requesting that the second wireless access point suspend communications while communication demands are reduced; and
the first wireless access point resuming operation at the first data rate in the first cell at the first size while communication demands are reduced.

5. The method of claim 1, further comprising:
adding and operating a plurality of second wireless access points so that each supports wireless communications at a second data rate in a corresponding plurality of second cells within the premises; and
s adjusting operation of the first wireless access point by increasing the data rate above the first data rate and correspondingly reducing the size of the first cell below the first size.

6. The method of claim 5, further comprising:
the adjusting operation of the first wireless access point comprising reducing the size of the first cell so that the first and plurality of second cells substantially cover the entire premises and so that the first and plurality of second wireless access points each operate at a data rate that is greater than the first data rate.

7. The method of claim 6, further comprising:
suspending operation of each of the plurality of second wireless access points while communication demands are reduced; and
adjusting operation of the first wireless access point to the first data rate in the first cell at the first size while communication demands are reduced.

8. The method of claim 6, further comprising:
coupling the first and plurality of second wireless access points together;
the first wireless access point monitoring communications within the premises and requesting that each of the plurality of second wireless access point suspend communications while communication demands are reduced; and
the first wireless access point resuming operation at the first data rate in the first cell while communication demands are reduced.

9. A wireless network providing wireless communication within a premises, the wireless network comprising:
a plurality of interconnected wireless access points;
each of the plurality of wireless access points providing wireless communications within a corresponding cell of a plurality of cells spaced to provide wireless coverage throughout the premises; and
a size of at least one cell of the plurality of cells that is dynamically adjustable based upon cell communication characteristics.

10. The premises based wireless network of claim 9, an operating data rate of at least one of the wireless access points being selectively adjusted to alter the size of a corresponding cell.

11. The premises based wireless network of claim 9, an operating data rate of at least one of the wireless access points being selectively increased to increase data throughput capability within a corresponding cell.

12. The premises based wireless network of claim 9, further comprising:
the data rate of a first wireless access point being selectively adjusted to increase the data throughput capability and to reduce the size of the corresponding cell; and
the data rate of a second wireless access point, neighboring the first wireless access point, being selectively adjusted to increase the size of a corresponding cell.

13. The premises based wireless network of claim 9, further comprising:
each of the plurality of wireless access points capable of operating according to first protocol at a first data rate; and
at least one of the plurality of wireless access points comprising a dual mode wireless access point capable of operating according to a second protocol that is substantially compliant with the first protocol, but that operates at a relatively lower data rate and within a relatively larger cell size.

14. The premises based wireless network of claim 13, further comprising:
at least one wireless terminal communicating with the at least one of the plurality of wireless access points within a corresponding cell according to the second protocol;
a roaming wireless terminal that can only operate according to the first protocol that enters the cell corresponding to the dual mode wireless access point; and
the dual mode wireless access point establishing communication with the roaming wireless terminal according to the first protocol.

15. The premises based wireless network of claim 13, further comprising:
a roaming wireless terminal that can only operate according to the first protocol that enters the cell corresponding to the dual mode wireless access point; and
the at least one the plurality of wireless access points adjusting the corresponding cell to operate according to the first protocol.

16. The premises based wireless network of claim 15, further comprising:
the at least one the plurality of wireless access points further communicating with the other of the plurality of wireless access points to adjust operation to the first protocol.

17. The premises based wireless network of claim 9, further comprising:
at least one of the plurality of wireless access points being selectively dormant such that it does not provide wireless communications; and
at least one other of the plurality of wireless access points adjusting its data rate and increasing a corresponding cell size to provide wireless communications in portions of the premises that were previously covered by a dormant wireless access point.

18. The premises based wireless network of claim 9, wherein:
the at least one selectively dormant wireless access point monitoring communications within a previously active corresponding cell; and
the at least one selectively dormant wireless access points becoming active to provide wireless communications within a corresponding cell when monitored communications exceed a threshold level.
